(19) United States
(12) Patent Application Publication
(10) Pub. No.: US 2008/0201053 A1
(43) Pub. Date: Aug. 21, 2008

(54) System and method for mixed gas chamber with automatic recovery

(75) Inventor: Zoe Gan Sze Hui, Singapore (SG)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: ESCO TECHNOLOGIES (Asia) PTE LTD, Singapore (SG)

(21) Appl. No.: 11/709,333

(22) Filed: Feb. 20, 2007

(51) Int. Cl. F02D 28/00

(52) U.S. Cl. 701/99

(57) ABSTRACT

A system for the introduction, monitoring and maintenance of pre-set levels of two or more gas components in a mixed gas chamber. The system has a micro-controller which monitors a pre-set level for each gas component in the mixed gas chamber using a plurality of sensors for each gas component. The system has an automated recovery with gas injection which automatically restore the level of each gas component to a pre-set level within the mixed gas chamber throughout all phases of operation of the mixed gas chamber, by injecting more gas of any gas component into the mixed gas chamber so as to maintain that gas component at the pre-set level whenever the pre-set level of that gas component is breached. The system has a redundant timed-sequence gas injection for all sequences of operation of the mixed gas chamber. A method of maintaining a pre-set level of two or more gas components in a mixed gas chamber using an automatic recovery with redundant time-sequenced gas injection is also provided.

### BACKGROUND OF THE INVENTION

A known technique in the art of mixed gas systems is to use high-precision flow resistors instead of apertures. However, the disadvantage of such devices is their sensitive response to changes in secondary pressure.

Another known technique is timed control of the mixing process. Fast acting valves produce gas segments which are mixed in a suitably dimensioned mixing chamber to form a homogeneous gas mixture. These cost-effective mixed gas systems, which are adjustable over a wide range, will help obtain accurate gas mixtures, where deviations from target values are less than 0.2%. Such a mixed gas system is disclosed in DE 31 35 455 A1. The two gas components (oxygen and nitrogen, for instance) are delivered via two component feed lines in order to obtain a predetermined mixing ratio. The two component feed lines are connected to a pneumatically controlled two-way valve, which will establish a timed connection between either one of the two feed lines and a common output line by means of a pulse generator for a predefined pulse duration determining the mixing ratio. By means of a pressure-reducing element the common output line is connected to a throttle whose outlet opens into a buffer tank. The gas mixture is withdrawn from the tank via a discharge line. The accuracy obtained with such mixed gas systems is limited mainly by the delay time of the two-way valve during switchover from one gas component to the other.

U.S. Pat. No. 4,392,514 describes a method and apparatus for precisely mixing gases in which solenoid valves sequentially feed separate gases to be mixed to a common pressure regulator and flowmeter.

U.S. Pat. No. 4,526,188 describes a method of mixing a plurality of gases in a specified proportion and dosing the resultant gas mixture comprises supplying individually controlled gas streams from suitable sources thereof in a pulse-like fashion to an enclosed chamber from where the resultant gas mixture can be delivered to a point of use. Each gas source is connected, via feed lines each having a back-pressure valve and an on-off solenoid valve, via a common flow line to an enclosed mixing chamber. Electrical signals in accordance with select properties of the gas streams are transmitted to a microprocessor-controlled regulating unit, which also controls the solenoid valves in accordance with a specified program to provide desired gas pulses to the enclosed mixing chamber.

U.S. Pat. No. 4,938,256 describes an apparatus for the production of particular concentrations of gaseous materials as well as for mixing different gaseous materials in a specified ratio in which the gaseous materials are supplied from different sources in pulsed fashion to at least one common outlet. The gaseous materials are passed through a valve which has n inlets and m outlets, n and m being whole numbers. This valve can connect at least one inlet for a specifiable time with a particular outlet. The valves are controlled preferably by a pulse-width modulated method, for example by means of a microprocessor.

U.S. Pat. No. 6,047,719 discloses a method for producing high-precision, continuous streams of mixed gases as well as a corresponding mixed gas system, which is adjustable over a wide range whilst achieving the same accuracy as conventional aperture arrangements. However, the electronic control as well as its slow ability to recover from a loss of gas concentration proposed in this prior art document could be further improved.

US 2004/0063195 discloses a similar approach for a CO₂ incubator wherein the CO₂ is accurately controlled with the use of gas sensors.

Most gas injection systems used in processes have to be in operation continuously. These gas injection systems would also suffer interruptions and disruptions such as when articles are introduced into the mixed gas chambers of such gas injection systems. These prior art systems do not have a method of quick recovery of gases when the concentration of gases inside the mixed gas chamber drop due to external disturbances. As a result, the entire process may have to be re-started, and the level of gas component in the gas chamber built up to the pre-set level required for the operation and a long period of time needs to elapse before the pre-set level is reached again.

### SUMMARY OF THE INVENTION

In one embodiment according to the invention, there is provided a system for the introduction, monitoring and maintenance of pre-set levels of two or more gas components in a mixed gas chamber. The system includes a micro-controller which monitors a pre-set level for each gas component in the mixed gas chamber using a plurality of sensors for each gas component. An automated recovery with gas injection automatically restores the level of each gas component to a pre-set level within the mixed gas chamber throughout all phases of operation of the mixed gas chamber, by injecting more gas of any gas component into the mixed gas chamber so as to maintain that gas component at the pre-set level whenever the pre-set level of that gas component is breached.

In further related embodiments, the system with an automated recovery with gas injection includes a microcontroller used to determine the pre-set level of each gas component in the gas mixture within the mixed gas chamber. The determination is based on pre-calculated timing of activation of each gas component and solenoids for each gas component alongside the control of sensors for each gas component in the mixed gas chamber.

The system with an automated recovery with gas injection may include a redundant time-sequenced gas injection, whereby the microcontroller maintains the pre-set level of each gas component in the gas mixture within the mixed gas chamber when the gas sensor fails and during the normal timed sequence.

In further embodiments, the system with an automated recovery with gas injection includes a redundant time-sequenced gas injection which applies for all these sequences:—
a. Normal timed sequence;
b. Recovery sequence;
c. Overshoot sequence; and
d. Intercession sequence
   in the operation of the mixed gas chamber.

The system with an automated recovery with gas injection may include a normal timed-sequenced gas injection which occurs when gas level is detected by gas sensors to be within the pre-set limits.

The system with an automated recovery with gas injection may include a recovery sequenced gas injection which occurs during cold starts and when doors of the mixed gas chamber are opened and closed allowing the mixed gas to escape the chamber.

The system with an automated recovery with gas injection may include an overshoot sequenced gas injection which occurs when gas levels in the mixed gas chamber go above a pre-specified percentage of the pre-set level and the gas injection commences when the gas level is once again within the pre-set limits, where normal time-sequenced gas injection takes over.

The system with an automated recovery with gas injection may include an intercession sequenced gas injection which commences when the gas level drops to between gas levels of those set for normal and recovery sequences.

In another embodiment, the system with an automated recovery with gas injection includes a microcontroller implementing a failsafe sequence which operates when the gas sensors fail, the failsafe sequence including:—
a. detecting erratic readings from a failed gas sensor; and
b. overriding the gas sensor's control;
the normal timed-sequence then continuing to function as per normal regardless of gas sensor readings, so that the pre-set level of each gas component of the gas mixture within the mixed gas chamber is kept at the pre-set level even when the gas sensors fail.

The system for an automated recovery with redundant time-sequenced gas injection system may include a microcontroller which determines the amount of each gas component to be introduced into the mixed gas chamber based on chamber size, flow rate and user defined percentage of gas component.

Further, the system for an automated recovery with redundant time-sequenced gas injection system may include a microcontroller which maintains each gas component at a pre-set level based on a determination of the amount of gas component to be maintained in the mixed gas chamber based on chamber size, flow rate and user defined percentage of gas component.

The system for an automated recovery with redundant time-sequenced gas injection system may also include a microcontroller which monitors the pre-set levels for each gas component with gas sensors to detect the level of the individual gas components within the mixed gas chamber.

The system for an automated recovery with redundant time-sequenced gas injection system may also include a microcontroller which monitors the level of each gas component with the gas sensors, and, based on the levels of each gas component relayed to the microcontroller, turns on injection of more of each component or turns off inflow of each gas component to bring each gas component back down to the pre-set level.

Another embodiment according to the invention provides a method of maintaining a pre-set level of two or more gas components in a mixed gas chamber using an automatic recovery with redundant time-sequenced gas injection, wherein the redundant time-sequenced gas injection applies to at least all these sequences:—
a. Normal timed sequence;
b. Recovery sequence;
c. Overshoot sequence; and
d. Intercession sequence.

The micro-controller may monitor and maintain the pre-set level for each gas component in the mixed gas chamber for each sequence based on a determination of the amount of gas component to be introduced into the mixed gas chamber, the determination based on chamber size, flow rate and user defined percentage of gas component. If the pre-set level of any one of the gas components is breached at any one sequence, the automatic recovery gas injection system releases more gas of that gas component into the chamber in order to maintain the pre-set level.

In a further related embodiment, the method of maintaining a pre-set level of two or more gas components in a mixed gas chamber includes a failsafe sequence upon failure of the gas sensors taking place, wherein the failsafe sequence includes: —
a. detecting an erratic reading from a failed gas sensor; and
b. overriding the gas sensor's control;
the redundant normal timed-sequence then continuing to function as per normal regardless of gas sensor readings; so that the pre-set level of each gas component of the gas mixture within the mixed gas chamber is kept at correct pre-set level even when the gas sensors fail and while waiting for the service technician to arrive.

In another embodiment, a carrier medium comprising computer readable code for implementing any of the above methods is provided.

### BRIEF DESCRIPTION OF THE DRAWINGS

For a better understanding of the invention, its advantages, and the objects attained by its use, reference should now be made to the accompanying drawings in which like reference characters refer to the same parts throughout the different views. The accompanying drawings illustrate one or more embodiments of the invention and together with the description herein, serve to explain the workings and principles of the invention.

FIG. 1 is a schematic diagram of a system according to an embodiment of the invention with two gas lines leading to the mixed gas chamber.

FIG. 2 is a schematic diagram of a system according to an embodiment of the invention with three gas lines leading to the mixed gas chamber.

FIG. 3 is a block diagram of a system according to an embodiment of the invention including a microcontroller monitoring gas component levels.

FIG. 4 is a block diagram of the internal structure of a computer system operating a microcontroller according to an embodiment of the invention.

### DETAILED DESCRIPTION OF THE INVENTION

An embodiment according to the invention provides a mixed gas system with an automatic recovery and redundant timed-sequence gas injection system for maintaining a pre-set level of each gas from a continuous stream of mixed gas consisting of a plurality of individually metered gas components, and a gas chamber wherein the mixed gases are introduced. If the pre-set level of any gas is breached, the automatic recovery gas injection system releases more of that specific gas that is deficient in the gas chamber in order to maintain the pre-set level.

Further, an embodiment according to the invention provides a system for a mixed gas chamber with automated recovery and redundant timed-sequence gas injection through all phases of operation. Such a system uses microcontroller determinations based on preset values resulting from specific parameters such as chamber size, flow rate and user defined gas level; and gas sensors which override the controls in the gas chamber to maintain the gas levels in the chamber within the pre-set levels. Gas sensors are used for fast recovery to the preset levels. Thereafter, the redundant timed-sequence takes over. Furthermore, this redundant timed-sequence allows the system to maintain preset levels in the event the gas sensor fails, whereupon the microprocessor then disables the gas sensors' readouts and their controls and lets the redundant timed-sequence take over.

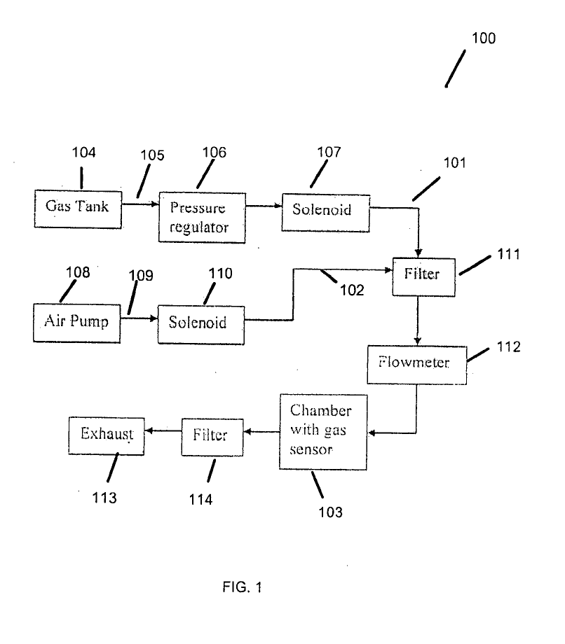

An embodiment of a system with automatic recovery and redundant timed-sequence gas injection for producing high-precision, continuous streams of mixed gases into the mixed gas chamber is now described with reference to FIG. 1. FIG. 1 is a schematic diagram of a system 100 according to an embodiment of the invention with two gas lines 101, 102 leading to the mixed gas chamber 103.

In this embodiment, the system 100 with automatic recovery and redundant timed-sequence gas injection consists of two gas lines, one (101) for the gas component and one (102) for air. It is possible for an embodiment to consist of more than two gas lines, say three gas lines, if the mixed gases consists of three gas components, each component gas having its own gas source and initial own gas line.

Referring to FIG. 1, there are two gas lines, one for gas 101 and one for air 102. The source for the gas component is a gas tank 104. The gas component is led from the gas tank 104 through a gas line 105, and to a pressure regulator 106 and a solenoid 107. The second gas component being air, in this embodiment, is pumped using an air pump 108 into the second gas line 109, which leads to a solenoid 110. The individual gases are then passed through a filter 111 to remove unwanted particulates before entering a flow meter 112. From the flowmeter 112, the mixed gases are passed through a joint outlet aperture into a mixed gas chamber 103. The high-precision, continuous mixed gas stream may be vented through an exhaust port 113 leading from the mixed gas chamber 103, but only through a filter 114.

In accordance with an embodiment of the invention, gases are supplied into the mixed gas chamber 103 in accordance with pre-set levels and the composition of the gas mixture maintained within the mixed gas chamber 103 at the pre-set level with the aid of pre-calculated timing for activation of the gas and air solenoids 107, 110 alongside the control of gas sensors in the mixed gas chamber 103. The pre-set levels are determined based on chamber size, flow rate, user defined percentage of gas using a microcontroller. In order for the mixed gases in the mixed gas chamber 103 to remain within the pre-set levels, the mixed gas chamber 103 is provided with gas sensors to detect the level of the individual gas components within the mixed gas chamber 103. The information on level of gas component within the mixed gas chamber 103 is then relayed to a microcontroller. Should any one gas component falls below its pre-set level, the gas sensor installed for the detection of that gas component detects this and sends the information to the microcontroller. The microcontroller also switches on the solenoid 107, 110 for the below pre-set level, releasing individual gas components through the filter 111 and through the flowmeter 112, into the mixed gas chamber 103. The gas component continues to flow into the mixed gas chamber 103 based on pre-set user defined values, the entire process being controlled by the microcontroller and based on computer program instructions stored in the microcontroller.

Once the gas levels of each gas component reaches the pre-set level for each gas component within the mixed gas chamber 103, the solenoid 107 or 110 is turned off. The gas mixture eventually settles into the pre-set equilibrium levels. To achieve this, it is possible for some of the gas component to be vented through an exhaust port 113 leading from the mixed gas chamber.

In accordance with an embodiment of the invention, the sequence of events leading to the introduction of a gas component into the mixed gas chamber 103 can be described as follows:—

a. Solenoids 107, 110 are controlled by a microprocessor to run in a timed sequence as per empirical data and equations.
b. Gas(es) are pumped in from compressed gas tanks 104, 108, and pressure is then regulated to an acceptable level.
c. The air pump 108 is paired with the solenoid 110 to open and close simultaneously, or air pump 108 may start slightly earlier.
d. Both gases then flow through an air filter 111 to remove unwanted particulates before entering a flowmeter 112.
e. The flowmeter 112 regulates and measures the flow of the gases before entering the mixed gas chamber 103 where the environmental proportion of gases is to be controlled.
f. The gases are channeled into the mixed gas chamber 103, and through natural convection and air currents, will mix and maintain the level of desired concentration.
g. To prevent pressure from building up in the mixed gas chamber 103, the air and gas escapes through an exhaust port 113, passing another filter 114 before entering the atmosphere.

Even though a description of the general working of the invention has been described, in accordance with an embodiment of the invention, it should be seen that the mixed gas chamber 103 would in operation go through a few phases:—

a. Normal timed sequence;
b. Recovery sequence;
c. Overshoot sequence; and
d. Intercession sequence

A description of each of the phases of operation of the system for a mixed gas chamber 103 with automated recovery and redundant timed-sequence gas injection for producing high-precision, continuous streams of mixed gases is now described, in accordance with an embodiment of the invention.

a. Normal Timed-Sequence
i. This occurs when gas level is detected by gas sensor to be within the preset limits. (e.g. +/−0.1% of 5.0%)
ii. Solenoids for gas and air pump paired with its solenoid but not switched on and off with it will alternate based on a preset values resulting from a specific set of calculations that involve chamber size, flow rate and user defined percentage of gas (e.g. X1 secs CO₂ solenoid open, Y1 secs air pump solenoid will open.)
iii. Within this range, the timed-sequence will maintain the mixture of air and gas in the mixed gas chamber 103 at the preset value.
b. Recovery Sequence
i. This occurs during cold start as well as almost all times such as when doors to the mixed gas chamber 103 are opened and closed.
ii. Once the gas levels are detected to be outside the preset limit, gases are injected into the mixed gas chamber 103 until it reaches the preset recovery limit (e.g. Z % for CO₂) and is then shut off for a preset amount of time e.g. N minutes. This gives the gas sensors time to detect the gas level in the mixed gas chamber 103 and prevents the gas level from overshooting the user defined level.
iii. Thereafter, the system goes into the Normal Timed-Sequence mode.
c. Overshoot Sequence
i. This sequence occurs when the gas levels in the mixed gas chamber go above a pre-set overshoot percentage, such as, for example, 0.1% of the preset level.
ii. The air pump 108 will kick in and continuously pump until the gas level is once again within the preset limits, where normal Timed-Sequence resumes.
d. Intercession Sequence
i. This sequence will automatically commence when the gas level drops to between the normal and recovery sequences gas limits.
ii. The solenoids for gas and air pump will then alternate based on preset experimental values (e.g. X2 seconds CO₂ solenoid will be kept opened, Y2 secs air pump solenoid kept opened).
iii. This enables a faster recovery while minimizing the possibility of an overshoot.

A description of a system for mixed gas chamber with automated recovery and redundant time-sequenced gas injection is described herein, in accordance with an embodiment of the invention. Such redundant time-sequenced gas injections are used in applications where a controlled gas-filled environment is maintained at a predetermined level, such as, for example, an incubator.

The gas mixture in a mixed gas chamber in operation must be kept at a specified level for each component gas and maintained at that specified level, for operational reasons. The entire operation has to be automated to ensure the gas levels in the mixed gas chamber stays within the pre-set limits for each gas component. However, there are occasions when the gases in the mixed gas chamber are not kept at the specified level such as during maintenance of the gas chamber, when the mixed gas chamber is exposed due to inadvertence or for introduction of products into the mixed gas chamber. When the mixed gas chamber is exposed to the outside elements, the level of the gas mixture falls to below the specified critical level based on the pre-set values. In accordance with an embodiment of the invention, once the critical level of the gas component is breached, the gas sensor for that gas component detects this and sends the information to the microcontroller. The microcontroller determines that the gas has fallen below preset limits and activates the recovery or intercession sequence accordingly. The introduction of additional gas component automatically brings the particular component of the gas mixture to the pre-set level once again. Once that specified level is automatically reached, the gas sensor detects this and sends the information to the microcontroller, which promptly switches off the supply of the particular gas component and switches to the Normal Timed-sequence injection of gas components. Any overshoot in the level of gas will be corrected either by the “Overshoot Sequence”, or the timed-sequence for small overshoots of 0.1% from set point. Any excess gas mixture in the gas chamber 103 will leak out on its own through an exhaust port 113 (a very tiny port). This part of the automatic recovery with redundant timed-sequence is termed as the “Normal Timed-Sequence”.

If the gas chamber 103 is decommissioned for maintenance, and then re-commissioned, the gas chamber 103 has to be filled with the gases required to make up the preset level of gas mixture in mixed gas chamber 103. In accordance with an embodiment of the invention, the filling up is based on a microcontroller procedure determined based on the size of that mixed gas chamber 103. Once the gas chamber 103 has been filled with the gases making up the gas mixture, the gas sensors detect that an equilibrium of gases at the pre-set level has reached, and the supply of gases is shut off. Control is then handed over to the “Normal Timed-Sequence”. This part of the automated recovery process with redundant timed-sequence is termed as the “Recovery Sequence”.

Where the gas mixture goes above the pre-set values, the system goes into an “Overshoot sequence” wherein the gas mixture is again adjusted until the gas components settle to the pre-set limits. Again, the overshoot sequence is detected by the gas sensors, which sends the information on gas levels to the microcontroller.

Although the automatic recovery with redundant timed-sequenced gas injection according to an embodiment of the invention caters for all stages of the system for mixed gas chamber, there may be occasions when failure of the sensors take place. Should such failure occur, one of the gas components in the gas mixture might exceed pre-set levels and consequently the other gas component might drop below the pre-set levels. Such failures would lead to imbalance of the gas mixture within the mixed gas chamber 103. Should this take place, the automatic recovery with redundant timed-sequence gas injection according to an embodiment of the invention is provided with a failsafe sequence, which works in the following manner:—
a. detecting erratic readings from a failed CO₂ sensor; and
b. overriding the sensor's control; the normal timed-sequence then continuing to function as per normal regardless of sensor readings.

This is a failsafe measure to ensure the pre-set gas mixture environment is kept at the correct levels even when the sensors fail and while waiting for the service technician to arrive, the gas chamber is operating within the pre-set operating environment.

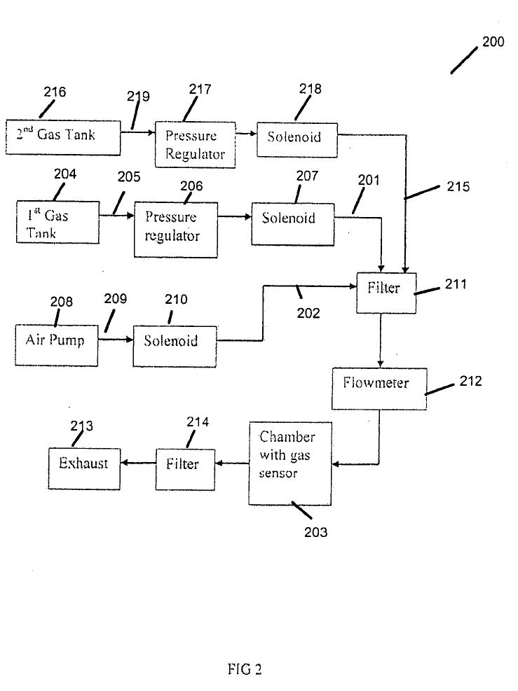

The embodiment in FIG. 1 describes a mixed gas chamber 103 with a system 100 for automatic recovery with redundant timed-sequence gas injection involving two gases. FIG. 2 describes an embodiment of a mixed gas chamber with a system 200 for automatic recovery with redundant timed-sequence gas injection for producing high-precision, continuous streams of mixed gases, involving three gases. In this embodiment, the system for automatic recovery with redundant timed-sequence gas injection consists of three gas lines 201, 202, 215, one for each type of gas component.

The individual gases are then passed through a filter 211 to remove unwanted particulates before entering a flow meter 212. From the flow meter 212, the mixed gases are passed through a joint outlet aperture into a mixed gas chamber 203. The high-precision, continuous mixed gas stream will simply leak out from an exhaust port 213 only through a filter 214 to prevent pressure built up. The operations of this second embodiment are identical to that of the first embodiment involving two gas lines. Again the automatic recovery with redundant timed-sequence gas injection uses microcontroller control based on parameters such as chamber size, flow rate, and user defined gas levels. The automatic process again covers the following timed-sequences:—

a. Normal timed sequence;
b. Recovery sequence;
c. Overshoot sequence; and
d. Intercession sequence

The second embodiment also has a fail safe sequence. Operation of air pump 208, first gas tank 204, second gas tank 216, solenoids 210, 218, pressure regulators 206, 217, and gas lines 205, 209, 219 is similar to operation of like components in the embodiment of FIG. 1.

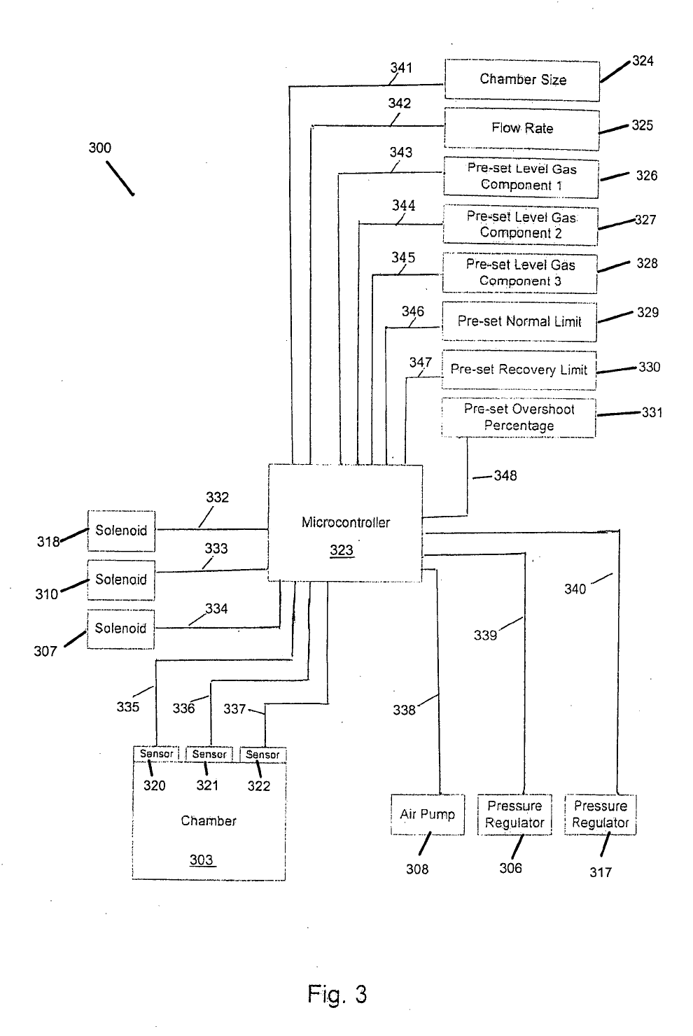

FIG. 3 is a block diagram of a system 300 according to an embodiment of the invention including a microcontroller 323 monitoring gas component levels. The microcontroller 323 is linked to other illustrated components of the embodiment of FIG. 3 by signal lines 332-348, which may be hardwired, wireless, cable or other signal lines enabling one-, two-, or more way communication of electrical and data signals between components, as will be appreciated by those of ordinary skill in the art. The microcontroller 323 receives signals related to measured individual gas component levels in mixed gas chamber 303 from gas sensors 320, 321, 322 for each individual gas component. Although three gas components are shown in the embodiment of FIG. 3, it will be appreciated that any number of two or more components may be used. Based on the microcontroller's 323 determination of the appropriate levels of each gas component using control techniques described herein, the microcontroller 323 communicates control signals over signal lines 332-334 to solenoids 307, 310, 318. According to the control signals, the solenoids 307, 310, 318 are activated as described in the embodiments of FIGS. 1 and 2 to turn on and off the inflow of each gas component into chamber 303 via gas lines (not shown in FIG. 3). The microcontroller 323 may also be used to control operation of air pump 308 and pressure regulators 306 and 317 as needed to introduce air and the first and second gas components into their respective gas lines (not shown in FIG. 3). The microcontroller 323 receives a number of pre-specified user inputs, such as chamber size 324, flow rate 325, pre-set levels 326-328 for each gas component, a pre-set normal sequence limit 329, a pre-set recovery sequence limit 330, and a pre-set overshoot percentage limit 331. Other pre-specified user inputs may also be supplied to the microcontroller 323, as will be appreciated by those of ordinary skill in the art. Using these pre-set inputs and the signals from the other components of the embodiment of FIG. 3, the microcontroller 323 uses programmed instructions to automatically determine operation of the solenoids 307, 310, 318 and other components, in accordance with control techniques described herein. The microcontroller 323 may include automatic control system components for implementing the solenoid timing sequence, pressure regulation, air pumping, normal timing sequence, recovery sequence, overshoot sequence, intercession sequence, automated recovery, redundant timed-sequence gas injection, failsafe sequence, and other control components and methods described herein.

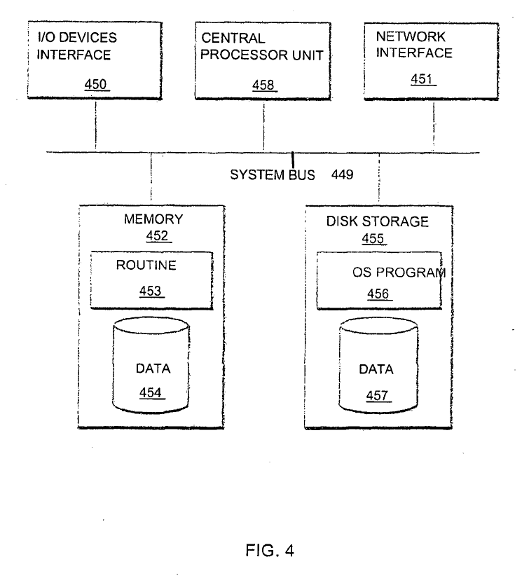

FIG. 4 is a block diagram of the internal structure of a computer system operating a microcontroller according to an embodiment of the invention. A microcontroller may also be implemented using other techniques, such as analog or digital control electronics or a combination of analog and digital control electronics, as will be appreciated by those of skill in the art. For example, the microcontroller may be implemented using an Application Specific Integrated Circuit (ASIC) or other dedicated digital or analog control electronics, which may use registers for data and program storage, and may communicated with a specialized device keyboard or other input/output device, as will be appreciated by those of ordinary skill in the art. In the embodiment of FIG. 4, microcontroller 323 of FIG. 3 (not shown in FIG. 4) may communicate signals directly or indirectly with a system bus 449 of a computer system. The system bus 449 may include data signal lines that interface with solenoid lines 332-334 and other signal lines of the embodiment of FIG. 3. System bus 449 is a set of hardware lines used for data transfer among the components of a computer or processing system. Bus 449 is essentially a shared conduit that connects different elements of a computer system (e.g., processor, disk storage, memory, input/output ports, network ports, etc.) that enables the transfer of information between the elements. Attached to system bus 449 is I/O device interface 450 for connecting various input and output devices (e.g., keyboard, mouse, displays, printers, speakers, etc.) to the computer. Network interface 451 allows the computer to connect to various other devices attached to a network. Memory 452 provides volatile storage for computer software instructions 453 and data 454 used to implement an embodiment of the present invention (e.g., routines for implementing control of a mixed gas chamber system). Disk storage 455 provides non-volatile storage for computer software instructions 456 and data 457 used to implement an embodiment of the present invention. Central processor unit 458 is also attached to system bus 449 and provides for the execution of computer instructions.

In one embodiment, the processor routines 453 and data 454 are a computer program product (generally referenced 453), including a computer readable medium (e.g., a removable storage medium such as one or more DVD-ROM's, CD-ROM's, diskettes, tapes, etc.) that provides at least a portion of the software instructions for any aspect of the invention system (e.g. control of a mixed gas chamber system). Computer program product 453 can be installed by any suitable software installation procedure, as is well known in the art. In another embodiment, at least a portion of the software instructions may also be downloaded over a cable, communication and/or wireless connection. In other embodiments, the invention programs are a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals may provide at least a portion of the software instructions for the present invention routines/program 453.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 453 is a propagation medium that the computer system may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

It should be noted that software and processing modules operating control techniques described herein could be implemented via the use of any number of computer programming languages. A computer system operating a microcontroller may be implemented using a number of different possible computer system arrangements, including by using several servers in parallel, in a server network, or otherwise associated to implement the invention described above. Also, a database associated with the computer system may be implemented using any number of database systems, including using several databases in parallel or otherwise associated with the computer system, and may be implemented using any number of database operating modules, languages, and techniques.

In accordance with an embodiment of the invention, automatic recovery with redundant timed-sequence gas injection system is time sequenced and operates automatically throughout all stages of operation of the gas injection system. The operations are controlled by a microcontroller based on computations of gas level requirements, gas chamber size and flow rate and gas inflows/outflows controlled based on gas sensors located within the mixed gas chamber. The quick recovery sequence for a constant flow system and the fail-safe operation due to the redundant timed-sequences enables the mixed gas chamber to be maintained at the correct gas levels without manual or operator intervention.

While an embodiment of the invention has been described in detail, it should be apparent, however, that other modifications, rearrangements, substitutions, alterations and adaptations in addition to these embodiments may occur to persons skilled in the art with the attainment of some or all of the advantages of the present invention. Accordingly, it should be clearly understood that the present invention is not intended to be limited by the particular features and structures hereinbefore described and depicted in the accompanying drawings. It is therefore intended to cover all such modifications, alterations and adaptations without departing from the scope and spirit of the present invention as defined by the appended claims.

What is claimed is:

1. A system for the introduction, monitoring and maintenance of pre-set levels of two or more gas components in a mixed gas chamber, the system including a micro-controller which monitors a pre-set level for each gas component in the mixed gas chamber using a plurality of sensors for each gas component,
wherein the system includes an automated recovery with gas injection to automatically restore the level of each gas component to a pre-set level within the mixed gas chamber throughout all phases of operation of the mixed gas chamber, by injecting more gas of any gas component into the mixed gas chamber so as to maintain that gas component at the pre-set level whenever the pre-set level of that gas component is breached.

2. The system with an automated recovery with gas injection as claimed in claim 1, wherein the microcontroller is used to determine the pre-set level of each gas component in the gas mixture within the mixed gas chamber based on pre-calculated timing of activation of each gas component and solenoids for each gas component alongside the control of sensors for each gas component in the mixed gas chamber.

3. The system with an automated recovery with gas injection as claimed in claim 1, wherein the gas injection is a redundant time-sequenced gas injection, whereby the microcontroller maintains the pre-set level of each gas component in the gas mixture within the mixed gas chamber when the gas sensor fails and during the normal timed sequence.

4. The system with an automated recovery with gas injection as claimed in claim 1, wherein the redundant time-sequenced gas injection applies for all these sequences:—
a. Normal timed sequence;
b. Recovery sequence;
c. Overshoot sequence; and
d. Intercession sequence
in the operation of the mixed gas chamber.

5. The system with an automated recovery with gas injection as claimed in claim 4, wherein a normal timed-sequenced gas injection occurs when gas level is detected by gas sensors to be within the pre-set limits.

6. The system with an automated recovery with gas injection as claimed in claim 4, wherein a recovery sequenced gas injection occurs during cold starts and when doors of the mixed gas chamber are opened and closed allowing the mixed gas to escape the chamber.

7. The system with an automated recovery with gas injection as claimed in claim 4, wherein an overshoot sequenced gas injection occurs when gas levels in the mixed gas chamber go above a pre-specified percentage of the pre-set level and the gas injection commences when the gas level is once again within the pre-set limits, where normal time-sequenced gas injection takes over.

8. The system with an automated recovery with gas injection as claimed in claim 4, wherein an intercession sequenced gas injection commences when the gas level drops to between gas levels of those set for normal and recovery sequences.

9. The system with an automated recovery with gas injection as claimed in claim 1, which further includes a microcontroller implementing a failsafe sequence which operates when the gas sensors fail, the failsafe sequence including:—
a. detecting an erratic reading from a failed gas sensor; and
b. overriding the gas sensor's control;
the normal timed-sequence then continuing to function as per normal regardless of gas sensor readings; so that the pre-set level of each gas component of the gas mixture within the mixed gas chamber is kept at the pre-set level even when the gas sensors fail.

10. A system for an automated recovery with redundant time-sequenced gas injection system as claimed in claim 1, wherein the microcontroller determines the amount of gas component to be introduced into the mixed gas chamber based on chamber size, flow rate, user defined percentage of gas component.

11. A system for an automated recovery with redundant time-sequenced gas injection system as claimed in claim 1, wherein the microcontroller maintains each gas component at a pre-set level based on a determination of the amount of gas component to be maintained in the mixed gas chamber based on chamber size, flow rate, user defined percentage of gas component.

12. A system for an automated recovery with redundant time-sequenced gas injection system as claimed in claim 1, wherein the microcontroller monitors the pre-set levels for each gas component with gas sensors to detect the level of the individual gas components within the mixed gas chamber.

13. A system for an automated recovery with redundant time-sequenced gas injection system as claimed in claim 1, wherein the microcontroller monitors the level of each gas component with the gas sensors, and based on the levels of each gas component relayed to the microcontroller, turns on injection of more of each component or turns off inflow of each gas component to bring each gas component to the pre-set level.

14. A method of maintaining a pre-set level of two or more gas components in a mixed gas chamber using an automatic recovery with redundant time-sequenced gas injection wherein the redundant time-sequenced gas injection applies to at least all these sequences:—
a. Normal timed sequence;
b. Recovery sequence;
c. Overshoot sequence; and
d. Intercession sequence
and wherein a micro-controller monitors and maintains the pre-set level for each gas component in the mixed gas chamber for each sequence based on a determination of the amount of gas component to be introduced into the mixed gas chamber, the determination based on chamber size, flow rate and user defined percentage of gas component and if the pre-set level of any one of the gas components is breached at any one sequence, the automatic recovery gas injection system releases more gas of that gas component into the chamber in order to maintain the pre-set level.

15. A method of maintaining a pre-set level of two or more gas components in a mixed gas chamber as claimed in claim 14, including a failsafe sequence upon failure of the gas sensors taking place, wherein the failsafe sequence includes: —
a. detecting an erratic reading from a failed gas sensor; and
b. overriding the gas sensor's control;
the redundant normal timed-sequence then continuing to function as per normal regardless of gas sensor readings; so that the pre-set level of each gas component of the gas mixture within the mixed gas chamber is kept at correct pre-set level even when the gas sensors fail and while waiting for the service technician to arrive.

16. A carrier medium comprising computer readable code for controlling a microcontroller to maintain a pre-set level of two or more gas components in a mixed gas chamber using an automatic recovery with redundant time-sequenced gas injection wherein the redundant time-sequenced gas injection applies to at least all these sequences:—
a. Normal timed sequence;
b. Recovery sequence;
c. Overshoot sequence; and
d. Intercession sequence
and wherein the micro-controller monitors and maintains the pre-set level for each gas component in the mixed gas chamber for each sequence based on a determination of the amount of gas component to be introduced into the mixed gas chamber, the determination based on chamber size, flow rate and user defined percentage of gas component and if the pre-set level of any one of the gas components is breached at any one sequence, the automatic recovery gas injection system releases more gas of that gas component into the chamber in order to maintain the pre-set level.

17. A carrier medium according to claim 16, the carrier medium comprising computer readable code for controlling a microcontroller to maintain the pre-set level of two or more gas components by carrying out a failsafe sequence upon failure of at least one gas sensor, wherein the failsafe sequence includes: —
a. detecting an erratic reading from a failed gas sensor; and
b. overriding the gas sensor's control;
the redundant normal timed-sequence then continuing to function as per normal regardless of gas sensor readings; so that the pre-set level of each gas component of the gas mixture within the mixed gas chamber is kept at correct pre-set level even when the gas sensors fail and while waiting for the service technician to arrive.
